(19) United States
(12) Patent Application Publication
(10) Pub. No.: US 2013/0256395 A1
(43) Pub. Date: Oct. 3, 2013

(54) SYSTEM FOR AND METHOD OF EXPEDITING SELF-CHECKOUT AT POINT-OF-SALE STATIONS

(71) Applicants: Edward BARKAN, Miller Place, NY (US); Mark Drzymala, St. James, NY (US)

(72) Inventors: Edward BARKAN, Miller Place, NY (US); Mark Drzymala, St. James, NY (US)

(73) Assignee: Symbol Technologies, Inc., Holtsville, NY (US)

(21) Appl. No.: 13/433,655

(22) Filed: Mar. 29, 2012

(51) Int. Cl. G06F 17/00

(52) U.S. Cl. 235/375

(57) ABSTRACT

An apparatus and method for expediting self-checkout at a point-of-sale station, employ a mobile electronic device, e.g., a cellular phone, held and operated by each customer. The device images one-dimensional symbols identifying items to be purchased, decodes the one-dimensional symbols to form decoded data, combines the decoded data to form one or more two-dimensional symbols, and displays each two-dimensional symbol on a display screen. Each displayed two-dimensional symbol is presented to a window of an electro-optical scanner at the point-of-sale station. The scanner images and decodes each displayed two-dimensional symbol to form a series of decoded data indicative of all the one-dimensional symbols, and sends the series of decoded data to a host network.

### FIELD OF THE DISCLOSURE

The present disclosure relates generally to a system for, and a method of, expediting self-checkout at point-of-sale stations.

### BACKGROUND

Retail establishments are trying to become more efficient by applying different and innovative operating methods that help to increase their business's financial condition. One of their constantly pursued goals is the reduction of a customer's waiting time in a checkout line. Being able to speed up the flow of customers through a checkout or point-of-sale (POS) station, or to reduce the cost of a checkout transaction, is critical to the success of a retail business. Manual price keying of each item being purchased, has been substantially replaced at each POS station by laser-based and/or solid-state imager-based electro-optical readers, also known as scanners, that automatically scan and read a machine-readable, bar code symbol, e.g., a one-dimensional symbol, particularly a Universal Product Code (UPC) bar code symbol, associated with each item. Examples of such scanners include handheld, portable scanners; stand-mounted, stationary scanners; vertical slot scanners; flat-bed or horizontal slot scanners; and bi-optical, dual window scanners.

In a typical retail checkout transaction, a customer has to present all the items he or she wants to purchase to a cashier at a checkout register at each POS station. The cashier scans the symbol on each item in the order in which it is presented to the cashier. In addition, there may be an identification check if the customer is purchasing a restricted item, such as, but not limited to, alcohol or tobacco. The transaction is completed once all the symbols on all the items have been scanned, the total cost has been calculated, and the customer has paid for the items. Even though scanning all the symbols on all the items at a checkout register takes less time than manually keying each item, the sequential presentation to the cashier of each individual item can take a long time and can create long lines of customers waiting to pay for their purchases. This can cause bottlenecks at the POS stations, reduce throughput, make customers unhappy, and affect the financial condition of the retail establishment. To alleviate such drawbacks, self-service checkout or “self-checkout” systems are employed, wherein each customer, rather than the cashier, scans the symbols on the items being purchased.

In a first type of self-checkout system, scanning takes place at the POS station. After selecting all the items, the customer brings all the items to the POS station, scans the symbols on all the purchases, scans symbols on any discount coupons, requests the final bill, and tenders payment. Even though this first self-checkout system reduces labor costs by not having the cashier scan each item at the POS station, it does not, in practice, reduce the customer's checkout time. In fact, it usually increases the time to checkout, because the customers are not as experienced at scanning the items as the cashiers are.

In a second type of self-checkout system, scanning takes place at the site of each item before the customer arrives at the POS station. Upon entering a store, each customer receives a mobile scanning terminal from a charging rack upon placing his or her identification or shopper loyalty card into a card reader (e.g., a magnetic stripe reader) at a log-in station, typically on the charging rack that stores multiple such terminals. Price information for each item in the store is downloaded from the store's computer network into a memory of each terminal during a time when system usage is low, or the system is non-operational. While shopping, the customer uses the terminal to scan symbols associated with the items intended to be purchased. Items can be added to, or removed from, each terminal. When item selection has been completed, the customer may either hand the terminal back to the cashier at the POS station, or the customer may simply place the terminal back into the charging rack. In either case, the terminal's contents, which has been stored in the scanning terminal's memory, is downloaded into the store's computer network, where a customer's transaction file is created for calculation of a final bill for settlement.

Even though this second self-checkout system offers many advantages over the first self-checkout system, there must be one terminal available per each potential customer. The costs of investing in a large number of terminals and in a number of terminal racks may be prohibitive for some retail establishments. Because the terminal has a fixed amount of memory, the size of information that can be stored inside the terminal is limited. Also, the price information displayed after scanning each item may not be synchronized to the store's network's price database, because the item price might have changed from the time when it was downloaded into the terminal to the time when the symbol for that item was scanned. In addition, the customer must leave the scanning terminal at the store and cannot take it home for personal use. Sometimes, the customer forgets to return the terminal, thereby causing the retail establishment to incur replacement costs.

In a variation of the second self-checkout system, rather than having the customers use scanning terminals provided by the store, the customers use their own cellular phones, smartphones and like mobile devices that have built-in cameras that can image symbols. Hence, the store need not incur the expense of purchasing, maintaining and recharging the terminals, as well as in purchasing, installing and maintaining specialized software to integrate the terminals with the store's existing computer network. Thus, it is known for a store to provide a shopping application, also known as an App, for download onto each customer's phone. The shopping application includes software that enables each phone to image the symbols on all the items to be purchased. At the POS station, in a checkout mode, the images of these symbols are successively displayed on a display screen of the phone. These displayed images are then scanned and read by image capture, one after another, at a specially programmed scanner at the POS station. Each image corresponds to one item. A shopping trip can, of course, have a multitude of items.

Although the known self-checkout systems that use phones are an improvement over those that use terminals, the sequential presentation of a multitude, e.g., a hundred, of images, one after another, to the scanner can still take a long time and can still create long lines of customers waiting to pay for their purchases. This can cause bottlenecks at the POS stations, reduce throughput, make customers unhappy, and adversely affect the financial condition of the retail establishment.

Also, as mentioned above, the store's network must be specially programmed to accept the succession of individual images, and to associate all the images with a particular customer, who is located at a particular POS station. Many retailers are strongly resistant to modifying their existing POS network software in any way due to fear of causing a problem that could hamper their ability to run their store. Extensive testing, considerable time and money, and unavoidable delay prevent many retailers from agreeing to modify their existing software. The cost of developing and debugging special software, and possibly also having to add or modify existing hardware in the store are concerns in preventing ready adoption of more efficient self-checkout systems.

Accordingly, it would be desirable to expedite checkout throughput by decreasing the amount of time needed to process item transactions at a POS station, without modifying existing POS network software.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagrammatic representation of multiple mobile devices and multiple point-of-sale stations in a retail store in accordance with this invention.

FIG. 2 is a front view of a representative mobile device displaying an electronic two-dimensional code to be imaged by a scanner at a point-of-sale station in the store of FIG. 1.

FIG. 3 is a part-schematic, part-diagrammatic view depicting various components of the representative mobile device of FIG. 2.

FIG. 4 is a perspective view of a representative point-of-sale station at which a representative scanner configured as a vertical slot scanner is installed.

FIG. 5 is a part-schematic, part-diagrammatic view depicting various components of the station of FIG. 4.

FIG. 6 is a flow chart depicting operation of the system and method in accordance with this invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

A system and method, in accordance with one feature of this invention, are operative for expediting self-checkout at a point-of-sale station. A mobile electronic device is held and operated by each customer. The device is advantageously configured as a cellular telephone, a smartphone, a personal digital assistant, a tablet, a computer, an e-reader, a media player, or a like portable device having a built-in imaging module. The device includes a device sensor for imaging one-dimensional symbols identifying items to be purchased; a device controller for decoding the one-dimensional symbols to form decoded data, and for combining the decoded data to form at least one two-dimensional symbol; and a display screen on which the at least one two-dimensional symbol is displayed by the device controller.

The at least one displayed two-dimensional symbol on the device is presented by the customer to a window of an electro-optical scanner at the point-of-sale station. The scanner is advantageously configured as a handheld, portable scanner; a stand-mounted, stationary scanner; a vertical slot scanner; a flat-bed, horizontal slot scanner: or a bi-optical, dual window scanner. The scanner includes a scanner sensor for imaging the at least one displayed two-dimensional symbol, and a scanner controller for decoding the at least one displayed two-dimensional symbol to form a series of decoded data indicative of all the one-dimensional symbols, and for sending the series of decoded data to a host network.

Advantageously, a manual interface on the device initiates imaging of each one-dimensional symbol. In a preferred embodiment, the device controller combines the decoded data to form a plurality of two-dimensional symbols, successively displays the plurality of two-dimensional symbols on the screen when presented to the window, and repetitively displays the plurality of two-dimensional symbols on the screen until the scanner controller has decoded all the plurality of two-dimensional symbols. The scanner controller determines how many of the plurality of two-dimensional symbols were formed, indicates to the customer how many of the plurality of two-dimensional symbols were formed, and sends the series of decoded data only after all the plurality of two-dimensional symbols have been decoded.

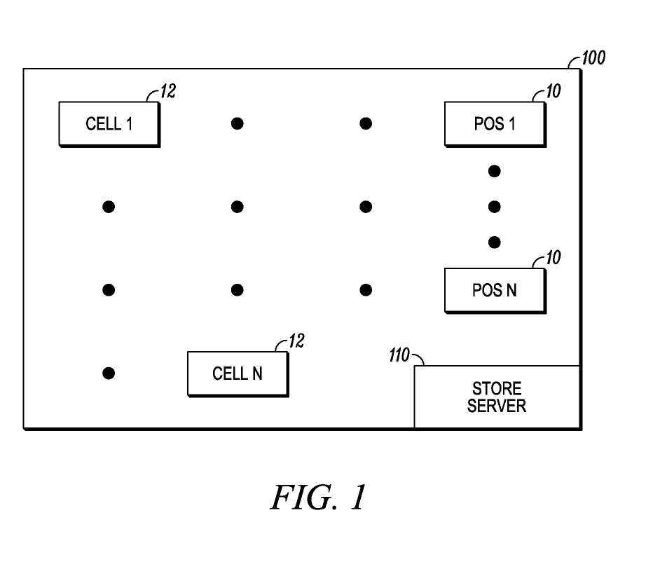

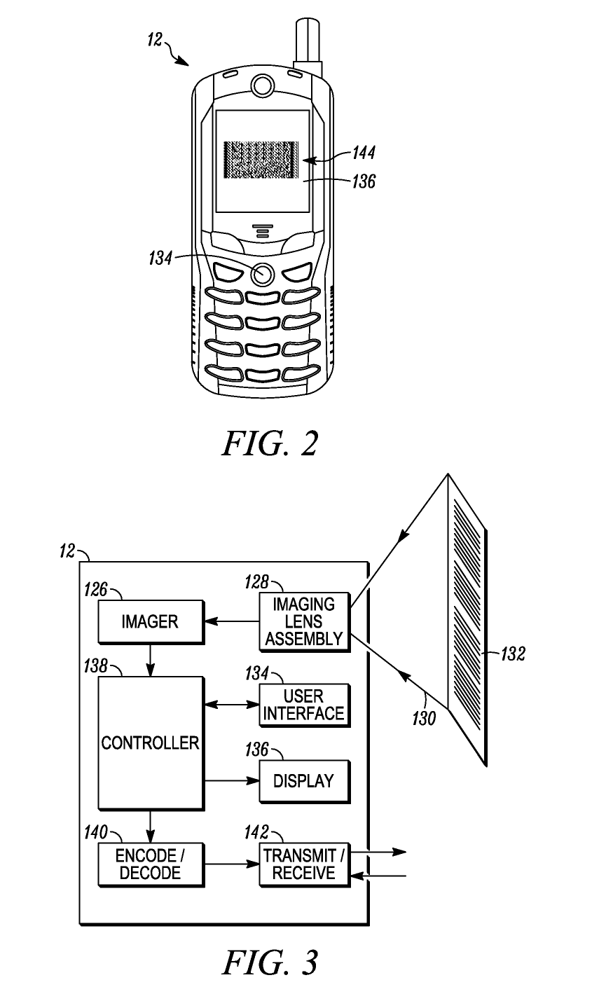

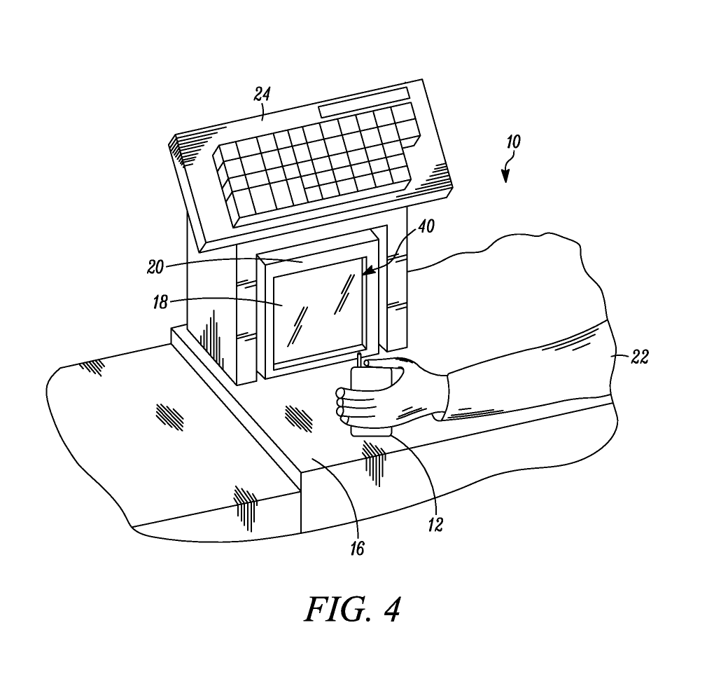

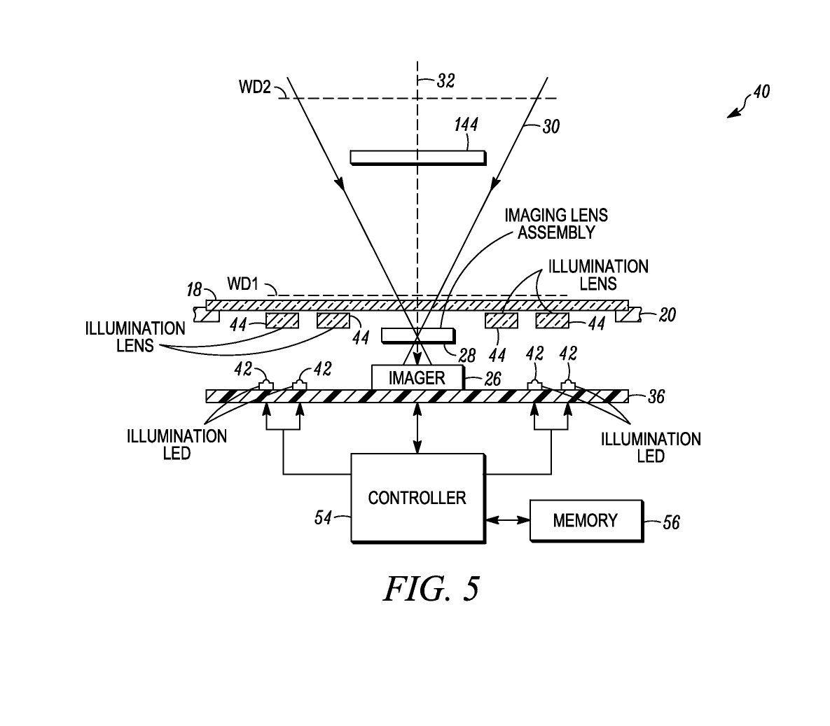

Reference numeral 100 in FIG. 1 generally identifies a retail store having a plurality of checkout or point-of-sale (POS) stations POS 1 . . . POS N, each generally identified by reference numeral 10 (a representative one of which is shown in FIGS. 4-5). Items to be purchased are distributed throughout the store 100, each item bearing, or being associated with, an identifying machine-readable, bar code symbol, e.g., a one-dimensional symbol, particularly a Universal Product Code (UPC) bar code symbol. As described below, shoppers or customers holding and operating mobile electronic devices CELL1 . . . CELL N, each generally identified by reference numeral 12 (a representative one of which is shown in FIGS. 2-3), travel through the store 100 during a shopping trip and select individual items to be purchased. All the stations 10 are in wired or wireless communication with a store server or host 110 that runs network software for processing the purchased items.

Each mobile electronic device 12 need not be configured as the illustrated wireless telephone of FIG. 2 (“cellular phone” or “smartphone”), but could be any portable device, such as a personal digital assistant (“PDA”), an e-reader, a tablet, a slate, a computer, a media player, or any like portable device generally carried on one's person and thus readily available and accessible. As shown in FIG. 3, the device 12 includes a device sensor or imager 126, e.g., a solid-state device, for example, a charge coupled device (CCD) or a complementary metal oxide semiconductor (CMOS) device, having a linear array of addressable image sensors or pixels, preferably of submegapixel or supermegapixel size, and an imaging lens assembly 128 mounted in front of the imager 126, for together capturing return light from, and imaging, one-dimensional symbols 132 that identify items to be purchased and that are located in a range of working distances relative to the device 12, over a reading field of view 130 that diverges away from the imaging lens assembly 128 in both horizontal and vertical directions.

The device 12 also includes a user interface 134, such as one of the keys on the device in FIG. 2, to manually initiate the imaging, a display screen 136, and a device controller 138, such as a programmed microprocessor. When the device is a phone, then an encode/decode module 140 and a transceiver module 142 are included. The device controller 138 controls operation of all the electrical components in the device 12 and, more particularly, is operative for decoding all the one-dimensional symbols 132 on all the items being purchased, each in its turn, to form decoded data, and for combining the decoded data to form at least one two-dimensional symbol 144 (see FIG. 2) for display on the display screen 136. Depending upon how many items are purchased, the device controller 138 may form a plurality of two-dimensional symbols 144.

The process of encoding a two-dimensional bar code symbol is described in detail in U.S. Pat. No. 5,243,655, the entire contents of which are incorporated herein by reference thereto. That patent describes a PDF417 bar code specification and describes how data is encoded into this type of two-dimensional bar code symbol. The PDF417 symbol 144 is capable of encoding more than 1100 bytes, 1800 text characters or 2710 digits. Large data files can be encoded into a series of linked PDF417 symbols using a standard methodology referred to as Macro PDF417. Further details describing encoding of information into a two-dimensional bar code symbol are available in ISO standard 15438, the entire contents of which are incorporated herein by reference thereto.

As shown in FIG. 4, each two-dimensional bar code symbol 144 displayed on the mobile electronic device 12 is presented to, or slid past and across, a generally vertical or upright, generally planar, light-transmissive window 18 of a box-shaped housing 20 of an imaging scanner or reader 40 configured as a vertical slot scanner mounted on a countertop 16 of the representative POS station 10. A consumer 22 is located at one side of the countertop 16, and the housing 20 is located at the opposite side. A cash/credit register 24 is located within easy reach of the user 22 to facilitate the processing and self-checkout of the item transactions. Although illustrated as a vertical slot scanner 40, the scanner 40 could also be configured as a handheld, portable scanner; a stand-mounted, stationary scanner; a flat-bed or horizontal slot scanner; or a bi-optical, dual window scanner. It will further be understood that the station need not be configured as being located at the illustrated checkout counter at a retail site with the cash register 24, but that other non-retail venues without the register 24 are contemplated.

The housing 20 of the scanner 40 of FIG. 4 includes, as schematically shown in FIG. 5, an image sensor or imager 26 mounted on a printed circuit board (PCB) 36, and an imaging lens assembly 28 mounted in front of the imager 26. The imager 26 is a solid-state device, for example, a CCD or a CMOS imager and has an area array of addressable image sensors or pixels, preferably of submegapixel or supermegapixel size, having a reading field of view 30 that diverges away from the window 18 in both horizontal and vertical directions. The imaging lens assembly 28 has an optical axis 32 generally perpendicular to the imager 26 and is operative for capturing light through the window 18 from each two-dimensional bar code symbol 144, which is located in a range of working distances along the optical axis 32 between a close-in working distance (WD1) and a far-out working distance (WD2), and for projecting the captured light onto the imager 26. In a preferred embodiment, WD1 is about two inches from the imager 26 and generally coincides with the window 18, and WD2 is about eight inches or more from the window 18.

An illumination light system is also mounted in the housing 20 and preferably includes a plurality of illumination light sources, e.g., two pairs of light emitting diodes (LEDs) 42, mounted on the PCB 36 and arranged at opposite sides of the imager 26. Two pairs of illumination lenses 44 are mounted in front of the illumination LEDs 42 to uniformly illuminate the target 50, 60 with illumination light. The number of illumination LEDs 42, the number of illumination lenses 44, and their locations can be different from those illustrated in the drawings.

The imager 26 and the illumination LEDs 42 are operatively connected to a scanner controller or programmed microprocessor 54 operative for controlling the operation of all these electrical components. A memory 56 is connected and accessible to the scanner controller 54. The scanner controller 54 is used for decoding light scattered from the two-dimensional symbol 144 and for processing the captured image. More particularly, the scanner controller 54 is operative for decoding each displayed two-dimensional symbol 144 to form a series of decoded data indicative of all the one-dimensional symbols 132, and for sending the series of decoded data to the host network server 110.

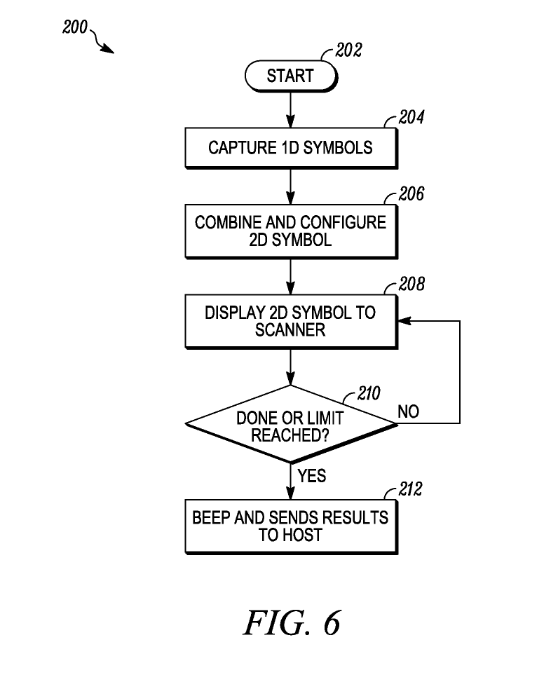

With the aid of the operational flow chart 200 of FIG. 6, in use, beginning at start step 202, a consumer can, in step 204, use his or her own device 12 to capture each image of one or more one-dimensional (1D) symbols 132 from newspaper circulars, and/or coupons, and/or displayed on a computer screen at home, prior to arrival at the store 100, and/or the consumer can use his or her own device 12 to capture each image of one or more one-dimensional symbols 132 on selected items to be purchased, and/or on a tag, and/or on the edge of a shelf, in the store. The device controller 138 decodes all these one-dimensional symbols 132, each in their respective turn, to form decoded data, and combines the decoded data, in step 206, into the single two-dimensional (2D) symbol 144, or in the event of a large number of one-dimensional symbols 132, into a smaller number of two-dimensional symbols 144 for display on the cellular phone's screen 136.

When subsequently presented to the window 18 of the scanner 40, the plurality of two-dimensional symbols 144 are successively displayed, in step 208, on the screen 136, e.g., every half-second, and repetitively displayed in a flashing sequence until the scanner controller 54 has successfully decoded all the two-dimensional symbols 144 in step 210. Advantageously, each two-dimensional symbol 144 can also include the consumer's identity and loyalty card information, as well as the number of the two-dimensional symbols 144 in the sequence.

The scanner controller 54 is specially programmed to decode each two-dimensional symbol 144 and separate out the data for each one-dimensional symbol 132, with a special ASCII delimiter that signals the end of data for one symbol 132, and the beginning of data for the next subsequent symbol 132. The scanner controller 54 also determines how many of the plurality of two-dimensional symbols 144 were formed, indicates, e.g., with a visual and/or auditory indicator, to the customer 22 how many of the plurality of two-dimensional symbols 144 were formed, and sends the series of decoded data to the host network server 110, in step 212, only after all the two-dimensional symbols 144 have been successfully decoded.

Thus, each two-dimensional symbol 144 advantageously contains data that indicates to the scanner 40 whether it is the only two-dimensional symbol 144 symbol that identifies all the items being purchased, or whether it is only one of several two-dimensional symbols 144 that identify all the items being purchased. For example, a first symbol 144 could indicate that it is the first of three symbols 144, a second symbol 144 could indicate that it is the second of three symbols 144; and so on. The scanner controller 54 would therefore know that it needs to scan three symbols 144, and will know when all three symbols 144 have been scanned. The scanner controller 54 can cause an indicator to indicate its scanning progress and the completion of the scanning process.

The host network server 110 receives the series of decoded data in the form of multiple, successive, one-dimensional symbols, which is exactly what the host network server 110 expects to receive. However, to the host network server 110, the multiple, successive, one-dimensional symbols are being received at a much higher rate than heretofore. In other words, rather than scanning a succession of one-dimensional symbols, one at a time, a single (or a few) two-dimensional symbols 144 are scanned, each one being automatically decoded into a multitude of one-dimensional symbols. This greatly expedites the self-checkout throughput by decreasing the amount of time needed to process item transactions at a POS station, and this is accomplished without modifying the existing POS network software in the host network server 110.

It will be understood that each of the elements described above, or two or more together, also may find a useful application in other types of constructions differing from the types described above.

In accordance with another feature of this invention, a method of expediting self-checkout at a point-of-sale station, is performed by holding and operating a mobile electronic device by each customer, imaging one-dimensional symbols identifying items to be purchased with a device sensor on the device, decoding the one-dimensional symbols to form decoded data with a device controller on the device, combining the decoded data to form at least one two-dimensional symbol with the device controller, displaying the at least one two-dimensional symbol on a display screen on the device, presenting the at least one displayed two-dimensional symbol to a window of an electro-optical scanner at the point-of-sale station, imaging the at least one displayed two-dimensional symbol with a scanner sensor on the scanner, decoding the at least one displayed two-dimensional symbol to form a series of decoded data indicative of all the one-dimensional symbols with a scanner controller on the scanner, and sending the series of decoded data to a host network.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements, but may include other elements not expressly listed or inherent to such process, method, article, or apparatus. An element proceeded by “comprises . . . a,” “has . . . a,” “includes . . . a,” or “contains . . . a,” does not, without more constraints, preclude the existence of additional identical elements in the process, method, article, or apparatus that comprises, has, includes, or contains the element. The terms “a” and “an” are defined as one or more unless explicitly stated otherwise herein. The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1%, and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors, and field programmable gate arrays (FPGAs), and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein, will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system for expediting self-checkout at a point-of-sale station, comprising:
a mobile electronic device held and operated by each customer, the device having
a device sensor for imaging one-dimensional symbols that identify items to be purchased,
a device controller for decoding the one-dimensional symbols to form decoded data, and for combining the decoded data to form at least one two-dimensional symbol, and
a display screen on which the at least one two-dimensional symbol is displayed by the device controller; and
an electro-optical scanner at the point-of-sale station, the scanner having
a window at which the at least one displayed two-dimensional symbol on the device is presented by the customer,
a scanner sensor for imaging the at least one displayed two-dimensional symbol, and
a scanner controller for decoding the at least one displayed two-dimensional symbol to form a series of decoded data indicative of all the one-dimensional symbols, and for sending the series of decoded data to a host network.

2. The system of claim 1, wherein the device is one of a cellular telephone, a smartphone, a personal digital assistant, a tablet, a computer, an e-reader, a media player, and like portable device having a built-in imaging module.

3. The system of claim 1, wherein the scanner is one of a handheld, portable scanner; a stand-mounted, stationary scanner; a vertical slot scanner; a flat-bed, horizontal slot scanner; and a bi-optical, dual window scanner.

4. The system of claim 1, wherein the device controller is operative for combining the decoded data to form a plurality of two-dimensional symbols, and for successively displaying the plurality of two-dimensional symbols on the screen when presented to the window.

5. The system of claim 4, wherein the scanner controller is operative for determining how many of the plurality of two-dimensional symbols were formed, and for sending the series of decoded data only after all the plurality of two-dimensional symbols have been decoded.

6. The system of claim 5, wherein the scanner controller is operative for indicating to the customer how many of the plurality of two-dimensional symbols were formed, and completion of the decoding and the sending.

7. The system of claim 4, wherein the device controller is operative for repetitively displaying the plurality of two-dimensional symbols on the screen until the scanner controller has decoded all the plurality of two-dimensional symbols.

8. The system of claim 1, wherein the device has a manual interface for initiating imaging of each one-dimensional symbol.

9. A method of expediting self-checkout at a point-of-sale station, comprising:
holding and operating a mobile electronic device by each customer;
imaging one-dimensional symbols that identify items to be purchased with a device sensor on the device;
decoding the one-dimensional symbols to form decoded data with a device controller on the device;
combining the decoded data to form at least one two-dimensional symbol with the device controller;
displaying the at least one two-dimensional symbol on a display screen on the device;
presenting the at least one displayed two-dimensional symbol to a window of an electro-optical scanner at the point-of-sale station;
imaging the at least one displayed two-dimensional symbol with a scanner sensor on the scanner;
decoding the at least one displayed two-dimensional symbol to form a series of decoded data indicative of all the one-dimensional symbols with a scanner controller on the scanner; and
sending the series of decoded data to a host network.

10. The method of claim 9, and configuring the device as one of a cellular telephone, a smartphone, a personal digital assistant, a tablet, a computer, an e-reader, a media player, and like portable device having a built-in imaging module.

11. The method of claim 9, and configuring the scanner as one of a handheld, portable scanner; a stand-mounted, stationary scanner; a vertical slot scanner; a flat-bed, horizontal slot scanner; and a bi-optical, dual window scanner.

12. The method of claim 9, wherein the combining is performed by combining the decoded data to form a plurality of two-dimensional symbols, and by successively displaying the plurality of two-dimensional symbols on the screen when presented to the window.

13. The method of claim 12, and determining how many of the plurality of two-dimensional symbols were formed, and sending the series of decoded data only after all the plurality of two-dimensional symbols have been decoded.

14. The method of claim 13, and indicating to the customer how many of the plurality of two-dimensional symbols were formed, and completion of the decoding and the sending.

15. The method of claim 12, and repetitively displaying the plurality of two-dimensional symbols on the screen until all the plurality of two-dimensional symbols have been decoded.

16. The method of claim 9, and initiating imaging of each one-dimensional symbol by manual interaction on the device.
